(19) United States
(12) Patent Application Publication
(10) Pub. No.: US 2006/0059544 A1
(43) Pub. Date: Mar. 16, 2006

(54) Distributed secure repository

(76) Inventors: Paul D. Guthrie, San Francisco, CA (US); Andrew L. Dale, Berkeley, CA (US); Michael Tolson, Madera, CA (US); Chistopher L. Buchanan, Foster City, CA (US)

Correspondence Address: CONVOII, INC., 1900 South Norfolk Street, Suite 135, San Mateo, CA, 94403, US

(21) Appl. No.: 10/943,495

(22) Filed: Sep. 17, 2004

Related U.S. Application Data
(60) Provisional application No. 60/610,098, filed on Sep. 14, 2004.
(60) Provisional application No. 60/610,008, filed on Sep. 14, 2004.

(51) Int. Cl. H04L 9/32

(52) U.S. Cl. 726/4

(57) ABSTRACT

A distributed secure repository and related methods allow users of a communications management system to securely store and share communications with other users. A user shares a communication by securely storing the communication, identifying the recipient, and specifying permissions that limit actions that the recipient is permitted to take with respect to the communication. Mechanisms are provided for limiting a recipient's ability to view, copy, store, forward, print, and modify the communication. Metadata associated with the communication is transmitted to the recipient, notifying the recipient of the securely stored communication. The recipient uses the metadata to request an encrypted copy of the communication, to view the communication, or to otherwise interact with the communication in accordance with the sender's permissions. The sender retains control of the communication and can modify the communication and associated permissions.

### PRIORITY CLAIMS AND RELATED APPLICATION

The present application claims priority benefit under 35 U.S.C. 119(e) from U.S. Provisional Application No. ______, entitled DISTRIBUTED SECURE REPOSITORY, filed Sep. 14, 2004 with Attorney Docket No. CJB.003PR, and from U.S. Provisional Application No., ______ entitled RELATIONSHIP-MANAGED COMMUNCIATIONS CHANNELS, filed Sep. 14, 2004 with Attorney Docket No. CJB.002PR, both of which are hereby incorporated herein by reference in their entireties. Furthermore, the present application is related to the co-pending and commonly owned U.S. Patent Application No. ______ entitled RELATIONSHIP-MANAGED COMMUNCIATIONS CHANNELS, filed on even date herewith with Attorney Docket No. CJB.002A and incorporated herein by reference in its entirety.

### FIELD OF THE INVENTION

The invention relates to the field of computer-assisted communications and, in particular, to the secure management of network-based communications using a distributed repository.

### BACKGROUND OF THE INVENTION

Computers and computer networks handle an increasing percentage of our communications with others. As techniques for generating, manipulating, and distributing data become faster, easier, and more widespread, many users desire to secure their communications such that unauthorized use of and access to their important and private communications does not occur. However, many conventional protocols for managing the transmission and storage of e-mails and other types of digital communications do not provide sufficient security and control to senders of the communications. Once a user sends an e-mail communication, for example, the sender typically cannot control who sees the communication, how they modify it, or with whom they share it. E-mails or other communications that are sent to a large number of recipients in a communication system result in a large number of copies of the same communication residing on various machines throughout. Furthermore, a user who sends data and subsequently desires to update the data has no easy and flexible method for locating and retracting all copies of the outdated data.

### SUMMARY OF THE INVENTION

Embodiments of the systems and methods described herein allow users to securely share communications with others over a computer network and to retain control over the communications that they share. A distributed secure repository is described that allows users of a communications management system to securely store and share communications with other users. A user wishing to share a communication with a recipient securely stores the communication, identifies the recipient, and specifies permissions that define actions that the recipient is permitted to take with respect to the communication. The recipient is notified that the communication is available for access in a secure storage repository controlled by the sender. Thus, securely storing a centrally available copy of a communication that is intended for a plurality of recipients reduces computer memory space used to store the communication across a communication system. In a preferred embodiment, the sender is provided with mechanisms for limiting a recipient's ability to view, listen to, read, copy, store, reply to, edit, modify, annotate, forward, print, and make a screen shot of the communication. The sender is also provided with mechanisms for specifying time limitations or other conditions on the recipient's access to the communication and for modifying permissions associated with a communication at any time. Metadata associated with the communication is transmitted to the recipient, notifying the recipient of the securely stored communication. The recipient may use the metadata to request an encrypted copy of the communication and, if permitted by the sender's permissions, may view a decrypted version of the communication on a secure viewer that is configured to enforce the permissions set by the sender. The recipient may additionally or alternatively perform other actions with respect to the communication as specified by the sender's permissions. The sender or sender's service provider continues to store the communication (in an encrypted form), allowing access to the communication to others only as desired, and thus retaining control over the recipient's access to the communication.

As used herein, the term “communication” is a broad term meant to encompass, in addition to its normal meaning within the field of digital transmissions, digital data in a wide range of formats that one user may wish to share with another. Communications, as used herein, include conventional e-mails, text files, documents, secure text messages, instant messages (IMs), short message service (SMS) files for cellular phone text messaging, faxes, digital photographs and other graphic and multimedia files.

The systems allow the communication owner to limit activities that the recipient may take with respect to the communication, for example: viewing, reading, listening, saving, copying, editing, annotating, modifying, forwarding, creating a screenshot, printing, or replying to a communication. In some embodiments, the systems allow the sender to limit devices on which the recipient may view a communication. For example, the owner may limit the recipient to devices identified by the system as being secure. Depending on the level of security appropriate within the context of the communication environment, permitted viewing devices may be limited to devices installed on a company's own network or even devices installed within secure areas where cameras or other recording devices are not permitted.

An embodiment of a system for securely managing communications between a sender of a communication and a recipient of the communication across a computer network is described such that the sender sets permissions associated with the communication which limit actions that the recipient is permitted to take with respect to the communication and such that the sender retains control of the communication, even after the communication is accessed by the recipient. The system comprises a sender computer device, a sender network service provider in communication with the sender computer device, a recipient network service provider, and a recipient computer device. The sender computer device includes a communication manager that allows the sender to identify a communication that the sender wishes to make available to the recipient, to set permissions limiting the activities which the recipient is permitted to carry out with respect to the communication, and to create a recipient list for the communication that includes the recipient. The sender network service provider receives an encrypted copy of the communication as well as the permissions and recipient list associated with the communication, and generates recipient metadata about the communication. The recipient metadata about the communication includes information that allows the recipient to contact the sender network service provider with a request for the communication. The sender network service provider comprises: a secure communications repository for storing the encrypted copy of the communication; and a security module which, in conjunction with a remote access manager module, oversees secure storage and network transmission of communications, recipient metadata, permissions, and recipient lists, and that authenticates the identity of any entity that contacts the sender network service provider, claiming to be the recipient and requesting access to the communication. The recipient network service provider, which is capable of receiving transmissions from the sender network service provider, comprises: a repository of recipient metadata for storing recipient metadata about the communication received from the sender network service provider; and a security module which oversees the secure storage of the recipient metadata and which provides single sign-on authentication for the recipient. The recipient computer device, which is in communication with the recipient network service provider, comprises a communications list. The communications list displays for the recipient a listing that is based at least in part on the recipient metadata received from the recipient network service provider, of communications that users of the system wish to make available to the recipient. The communications list includes a listing for the communication from the sender, and receives instructions from the recipient to use the recipient metadata and the single sign-on authentication to contact the sender network service provider with a request for a secure copy of the encrypted communication and the permissions. The recipient user device 100 also comprises a secure viewer for displaying a decrypted version of the communication to the recipient, if permitted by the permissions, and for enforcing the permissions, which limit the recipient's ability to carry out activities with respect to the communication, such as viewing, storing, modifying, creating a screen shot, or forwarding the communication.

An embodiment of a method for managing communications that are transmitted over a computer network between a sender and a recipient is described, wherein the sender retains control over the communication, even after transmission to the recipient, and wherein the sender is provided with mechanisms for setting permissions that limit activities, such as viewing, copying, modifying, storing, forwarding, and printing, that the recipient is permitted to carry out with respect to the communication. The method comprises receiving a communication that the sender wishes to share with a recipient as well as a recipient list and a set of permissions in association with the communication. The method further comprises securely storing the communication and generating metadata associated with the communication, as well as transmitting the metadata to the recipient. The metadata comprises information that identifies the sender, the communication, a network address and other locating information for the securely stored communication, and it allows the recipient to transmit a request for the communication. The method further comprises receiving a request for the communication from an entity claiming to be the recipient, validating the entity's identity as the recipient; and securely sending an encrypted version of the communication to the recipient along with the permissions, wherein the communication is viewable only on a secure viewer that is configured to enforce the permissions set received from the sender.

An embodiment of a system for securely managing communications between a sender of a communication and a recipient of the communication across a computer network is described, such that the sender sets permissions associated with the communication which limit actions that the recipient is permitted to take with respect to the communication and such that the sender retains control of the communication, even after the communication is accessed by the recipient. The system comprises: a communication manager on a sender computer device, a sender network service provider, a recipient network service provider, and a recipient computer device. The communication manager on the sender computer device allows the sender to set permissions with respect to a communication that the sender wishes to share with a recipient. The permissions place limitations on activities that the recipient is permitted to carry out with respect to the communication, such as limiting the recipient's ability to view the communication, print the communication, store the communication, modify the communication, copy the communication, forward the communication, and such as limiting time periods during which the recipient may carry out an activity with respect to the communication, and such as limiting a number of times that the recipient may carry out an activity with respect to the communication. The sender network service provider is in communication with the communication manager on the sender computer device and is configured to: accept from the communication manager an encrypted copy of the communication, the permissions associated with the communication, and a recipient list associated with the communication that lists the recipient. The sender network service provider is further configured to securely store the encrypted communication in a repository of encrypted communications to create and store recipient metadata about the communication. The recipient metadata is based at least in part on the recipient list, on the encrypted communication, and on the permissions received from the communication manager. The repository further comprises information which allows the recipient to contact the sender network service provider with a request for the communication. The sender network service provider is further configured to send the recipient metadata, to receive a request for the communication on behalf of the recipient, and, if permitted by the permissions associated with the communication, to send an encrypted copy of the communication and the permissions for the recipient. The recipient network service provider is configured to receive and store the recipient metadata from the sender network service provider. The recipient computer device, which is in communication with the recipient network provider, is configured to: receive the recipient metadata from the recipient service provider; to use information in the recipient metadata to establish a connection with the sender service provider; to send a request for the communication to the sender service provider; if permitted by the permissions, to receive an encrypted copy of the communication and the associated permissions; if permitted by the permissions, to display to the recipient a decrypted version of the communication on a secure viewer that is configured to enforce the permissions; and if permitted by the permissions, to carry out another activity with respect to the communication.

An embodiment of a computer-based method for securely managing a communication between a sender and a recipient is described. The method comprises the acts of: receiving an encrypted communication that a sender wants to make accessible to a recipient; securely storing the encrypted communication; storing sender metadata associated with the communication that includes information about a set of actions that the sender allows the recipient to take with regard to the communication; and sending recipient metadata to a computer server associated with the recipient to notify the recipient about the communication.

An embodiment of a computer-based system for managing a communication between a sender and a recipient is described. The system comprises: a first repository that is maintained by a sender for securely storing an encrypted version of a communication; a second repository that is maintained by the sender for storing sender metadata associated with the communication; and a communications system accessible to the sender for sending recipient metadata associated with the communication to a computer server associated with the recipient, wherein the recipient metadata provides an indication to the recipient server of how to access the communication.

An embodiment of a computer-based method for managing communication notifications received by a recipient is described. The method comprises maintaining a repository of listings that notify a recipient of a message about communications that one or more senders are securely storing. The method further comprises using at least a portion of one listing that notifies about a communication to communicate with a computer server that is associated with the sender of the communication, requesting to perform a permitted action with regard to the communication, wherein the sender determines if the action is permitted to the recipient.

An embodiment of a computer-based communications system is described. The system comprises a first network service provider that manages data communications for a first user and a central directory that stores information for accessing a second network service provider and that is accessible to the first network service provider. The computer-based communications system further comprises a database that includes at least one encrypted file stored by the first network service provider on behalf of the first user and metadata about the encrypted file stored by the first network service provider. The metadata comprises permissions that limit the second user's ability to perform actions with respect to the file. The computer-based communications system also comprises secure repository server software that is stored by the first network service provider and that is configured to receive the information for accessing the second network service provider, to open a communication channel with the second network service provider; and to transmit at least a portion of the metadata to the second network service provider for passing to the second user.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIGS. 1A and 1B form FIG. 1, which is a block diagram depicting one embodiment of a distributed secure repository for computer-assisted communications.

FIG. 2 depicts a simplified version of one embodiment of an outgoing communication manager user interface.

FIG. 3A depicts one embodiment of a repository of sender metadata.

FIG. 3B depicts one embodiment of a repository of recipient metadata.

FIG. 4 is a flowchart of one embodiment of a process for notifying a recipient about a communication.

FIG. 5 is a flowchart of one embodiment of a process for allowing permitted access to a communication by a recipient who requests the access.

FIG. 6 is a flowchart of one embodiment of a process for updating a communication.

FIG. 7 is a flowchart of one embodiment of a process for receiving a communication.

### DETAILED DESCRIPTION OF THE PREFERRED EMBODIMENT

In general, the distributed secure repository system described herein securely manages the creation, storage, and sharing of communications between users of the distributed secure repository system.

As used herein, the term “communication” is a broad term meant to encompass, in addition to its normal meaning within the field of digital communications, digital data in a wide range of formats that one user may wish to share with another. Communications, as used herein, include conventional e-mails, secure text messages, text files, instant messages (IMs), short message service (SMS) files for cellular phone text messaging, faxes, digital photographs, other graphic and multimedia files, and other types of data that may be transmitted between users across computer-assisted networks. In addition to documents and files intended as communications from one user to another, the term communication, as used here, also applies to data that a user wishes to share, and possibly even modify together, with one or more other users.

As used herein, the term “sender” refers to a user who wishes to allow another user, known herein as a “recipient,” some access to a communication that the “sender” controls. Thus, “sending” a communication within the context of the distributed secure repository is not limited to situations in which the sender transmits the communication to the recipient. Preferably, the communication is securely stored on a computer server associated with the “sender.” The recipient is sent a notification about the communication and may request a copy of the communication. If the recipient requests and receives a copy of the communication, and if permitted by the sender, the recipient may save a copy of the communication on a recipient user device. However, if the sender does not permit the recipient to save a copy, the recipient is not able to do so. Similarly, the sender defines other actions that the recipient is permitted to take with respect to the communication. The communication remains securely stored on the sender's server.

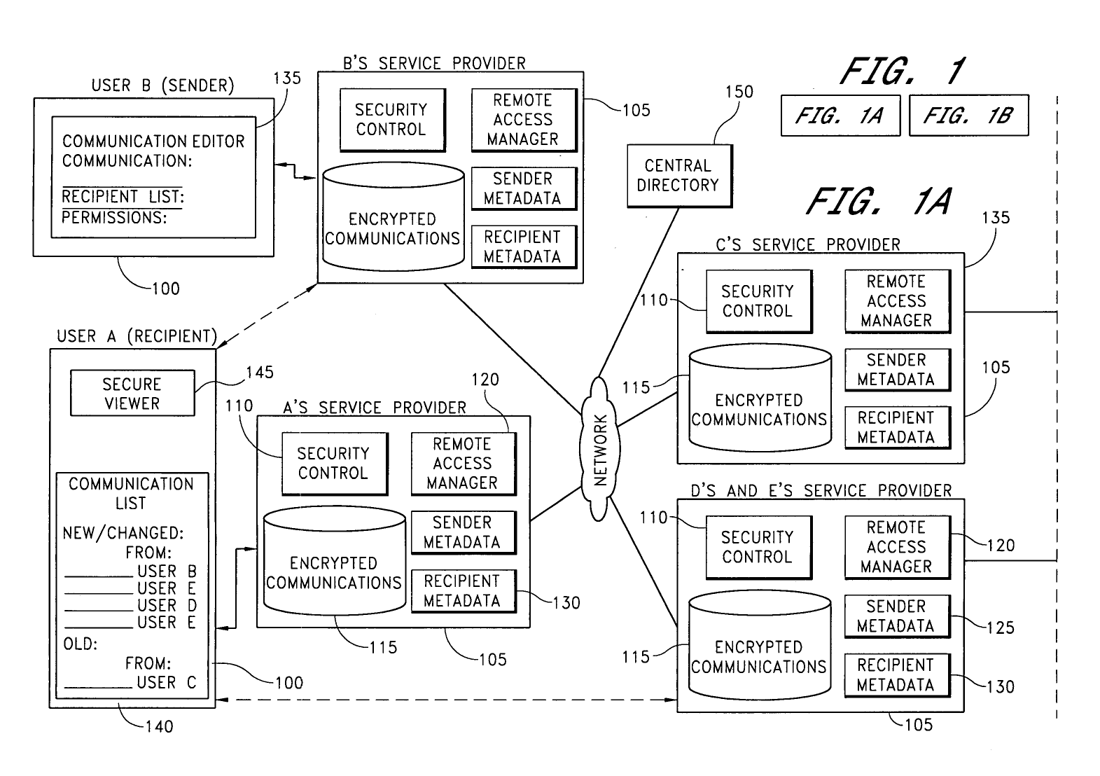

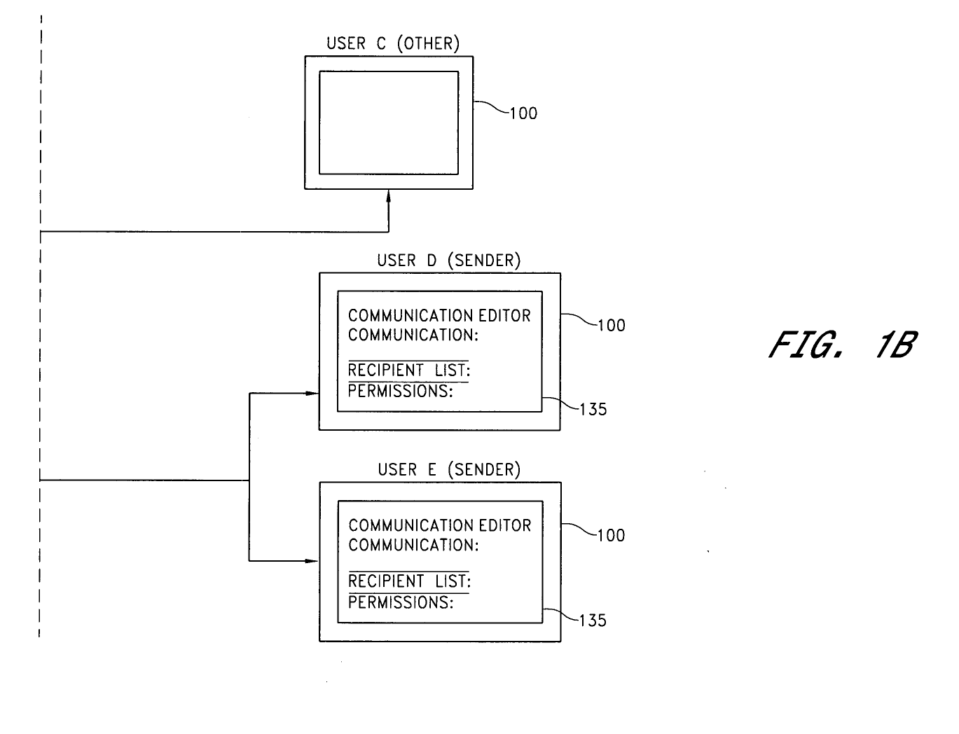

As depicted in FIG. 1, users of a distributed secure repository system, identified here as User A, User B, User C, User D, and User E, communicate with other users by way of user computer devices and their respective network services providers 105, which are interconnected using a communications network, such as the Internet or other computer-based communications network. As used herein, user computer devices, also known a user client devices to differentiate them from their network service providers, include personal computer (PCs), workstations, laptops, notebooks, personal digital assistants (PDAs) and other portable computer devices, as well as other communications devices with embedded computer processors, such as cellular phone. Such devices will be known for purposes of this description as user devices.

For purposes of this description and in order to simplify explanation of the features of the distributed secure repository, users of the system will be described with reference to their roles as recipients or as senders of communications. Thus, in FIG. 1, one of the users, User A, is identified as being a recipient of communications, and three of the users, User B, User, D, and User E, are identified as being senders of communications. However, as will be appreciated by persons of ordinary skill in the related art, users of the distributed secure repository system commonly act as senders and as recipients of various communications. Thus, it will be understood that functions described as being performed by User A as a recipient of communications may also be performed by Users B, C, D, and E when they are recipients of a communication.

Similarly, functions described as being performed by Users B, D, and E as senders of communications may also be performed by Users A and C when they act as senders of a communication. Data structures, software modules, communications links, and other structural components described in particular as being associated with users who are recipients of communications or with users who are senders of communications should be understood as being associated in general with users of the distributed secure repository system.

Furthermore, although, for ease of description, a user who creates a communication, designates other users as recipients of the communication, and retains control over storage and distribution of the communication is referred to as the “sender” of the communication, the systems and methods described herein provide for these functions to be carried out by different users at different times. For example, one user may begin creation of a communication and may subsequently transfer control of the communication to another user who may or may not modify or continue to create the communication, but who henceforth controls secure storage of the communication and of the permissions associated with the communication.

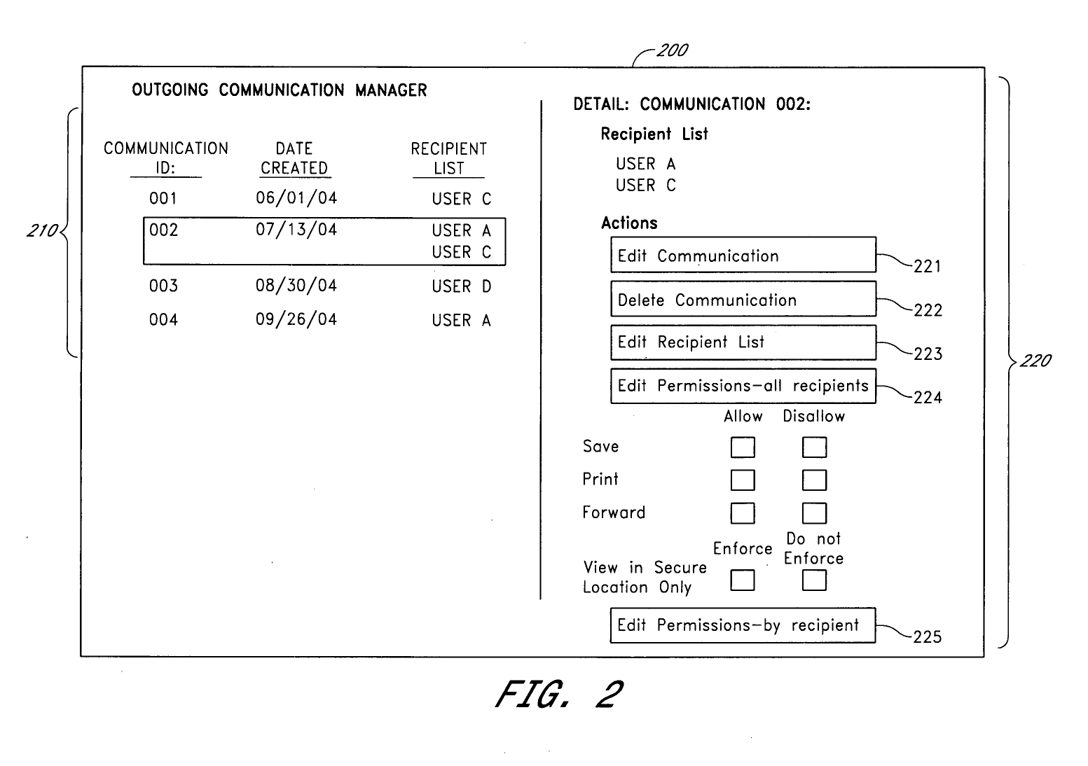

As depicted in the embodiment shown in FIG. 1, senders of a communication make use a communication editor 135 on the user device 100 to compose or otherwise create the content of a communication that they wish to make available to one or more recipients. The communication editor 135 preferably provides users with facilities for composing, modifying, spellchecking, and performing other functions in the creation of their communications that the users may be accustomed to having available with conventional e-mail and word processing systems or other systems, as appropriate to the type of communication. The embodiment of the communication editor 135 shown in FIG. 1 allows the sender to create the content of the communication, to create a recipient list for the communication, and to define permissions that the sender imposes associated with the communication. The definition of permissions and other instructions associated with a communication is described below in greater detail with reference to the secure viewer of FIG. 1 and with reference to FIG. 2 to follow. Furthermore, one embodiment of the distributed secure repository system described herein may be used to implement a system of relationship-managed communications channels that allow users to define rules designating other users who may communicate with them, communications channels that the designated users may use for communicating with them, time periods during which the designated users may communicate with them, and other conditions associated with communications from other users. Embodiments of a relationship-managed communications system are described in U.S. Provisional Application No. ______, entitled RELATIONSHIP-MANAGED COMMUNCIATIONS CHANNELS, filed Sep. 14, 2004 with Attorney Docket No. CJB.002PR, and U.S. Patent Application No. ______ entitled RELATIONSHIP-MANAGED COMMUNCIATIONS CHANNELS, filed on even date herewith with Attorney Docket No. CJB.003A, both of which are incorporated herein by reference in their entireties.

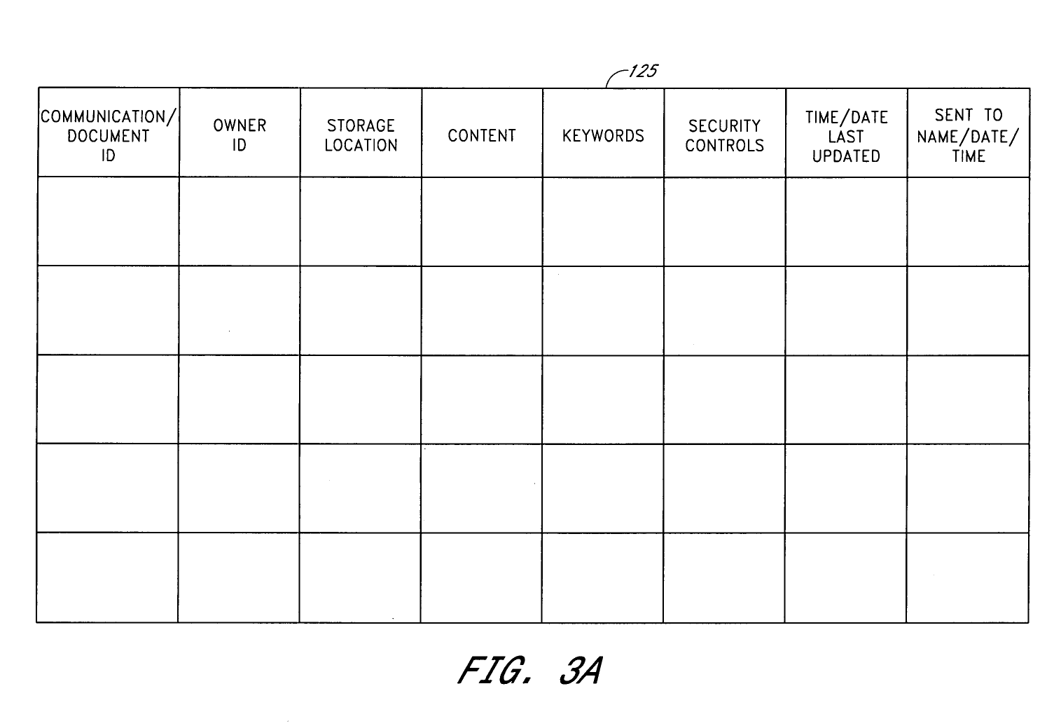

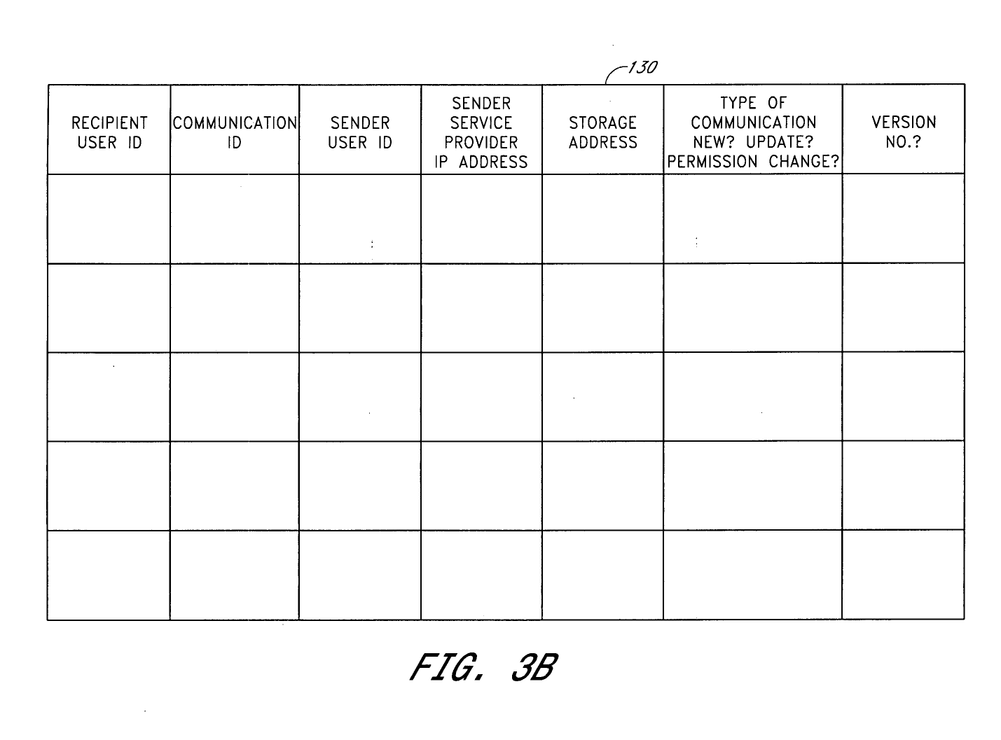

The sender encrypts the created communication and transmits the encrypted communication along with the associated recipient list, permissions, and any additional instructions to the sender's service provider 105. The service provider 105 securely stores the encrypted communication in a secure communication repository 115. The service provide further stores at least a portion of the recipient list, permissions, and any additional instructions received from the sender as sender metadata 125. The sender metadata 125 includes descriptive and administrative information about the communication that allows the service provider 105 to control access to the communication on behalf of the sender, as will be described in greater detail with reference to FIG. 3A.

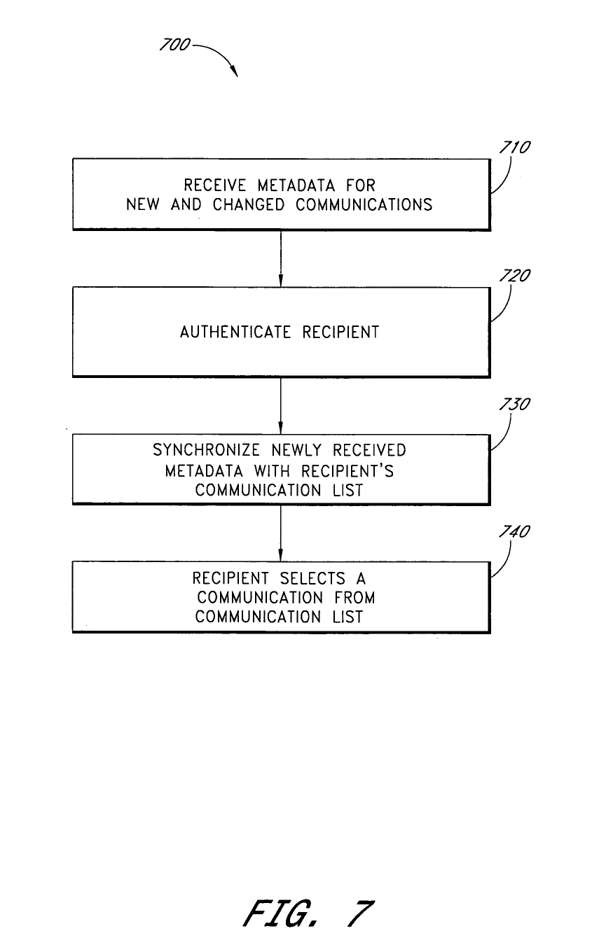

The service provider 105 also creates recipient metadata for transmission to users listed on the recipient list. The recipient metadata allows the recipient to identify and request the communication from the sender's service provider 105, as is described below in greater detail with reference to FIG. 7.

A remote access manager 120 transmits the recipient metadata about the communication to the recipient's service provider 105. In a preferred embodiment of the invention, users are permitted to identify themselves to other users using a pseudonym or username. Furthermore, network contact information associated with the username is changed by the user transparently to other users who continue to refer to the user with the username. The remote access manager 120 advantageously stores internet protocol (IP) addresses or other network navigating information associated with usernames that have been recently user by the sender's service provider 105. However, when the IP addresses or other network navigating information for the recipient is not available to the network service provider, the remote access manager 120 advantageously accesses a central directory 150, which may be implemented as a database with look-up mechanism that lists user profiles, or, in some embodiments, simply lists the IP addresses of network service providers. The central directory 150 may be implemented as a single entity or may be implemented as a distributed across a set of trusted, federated servers.

The recipient's service provider 105 receives the recipient metadata and stores the recipient metadata in a repository of recipient metadata 130. The recipient's service provider 105 uses the stored recipient metadata 130 to update a communication list 140 that is displayed to the recipient on the recipient's user device.

In some embodiments, the repository of recipient metadata 130 stored on a user's network service provider 105 comprises recipient metadata associated with communications that a sender wishes to make available to the user as well as recipient metadata that the user has generated regarding communications that the user has created and made available to other recipients. In a preferred embodiment, the repository of recipient metadata 130 comprises information about communications for which the user is a recipient, and the repository of sender metadata 125 comprises information about communications for which the user is the sender.

The recipient's communication list 140 provides a listing of new and old communications that have been made available to the recipient from users of the distributed secure repository system. The recipient's communication list preferably includes listings of individual communications created by other users and made available to the recipient. A listing that notifies the recipient of a newly-available communication preferably includes a link that the recipient may “click” or otherwise select, thereby allowing the recipient to directly access the communication which is stored securely on the sender's service provider 105.

The link preferably includes identifying information about the service provider 105 that is usable by the recipient's user device 100 for navigating the network and initiating a network-mediated request to access the communication identified by the link. Thus, the link also preferably includes identifying information about the communication and, in some embodiments, location information indicative of the communication's storage location of the repository of encrypted communications 115 on the sender service provide 105.

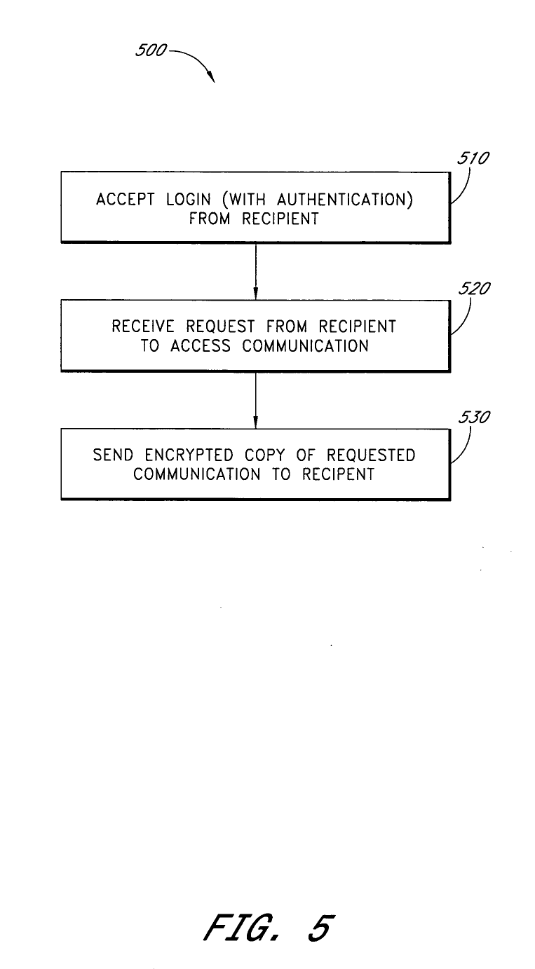

In various embodiments, the remote access manager 120 on the sender's service provider 105 accepts the recipient's request to access the securely stored communication. Before providing access to the communication, the remote access manager 120 authenticates the identity of the recipient, as is described below in greater detail with reference to FIG. 5, and, if satisfied of the correct identity of the recipient, initiates a session with the recipient.

If permitted by the permissions associated with the communication as set by the sender of the communication, the recipient downloads the desired communication in its encrypted form as well as the permissions associated with the communication. The recipient 100 advantageously includes a secure viewer 145 that is configured to enforce the communication's associated permissions as defined by the sender. The secure viewer 145 is preferably further configured to decrypt the communication for viewing by the recipient. For example, in various embodiments, the secure viewer 145 is configured to enforce permissions that may, as defined by the sender, restrict the recipient's ability to perform at least one of: printing the communication, saving the communication, forwarding the communication via e-mail, making a screen-print of the communication, placing the communication on a clipboard, and other activities that may compromise the security of the communication.

In various embodiments, specialized secure viewers 145 are provided on the recipient's device for providing access to different types of communications. For example, in a preferred embodiment, specialized secure viewers 145 are provided for viewing, and manipulating, if permitted, secure messages, Adobe PDF documents, and MS Word documents. Other embodiments also provide specialized secure viewers 145 for MS PowerPoint and WordPerfect documents. As will be appreciated by a skilled artisan, specialized secure viewers 145 for viewing, listening to, and/or manipulating other types of communications may advantageously be provided by embodiments of the distributed secure repository.

In various embodiments, the distributed secure repository system enforces varying levels of security regarding storage, transmission, and access to communications managed by the system. In a preferred embodiment, the system enforces a high level of security, as carried out, at least in part, by a security control module 110 on the users' service providers 105 and by secure viewers 145 on the user devices 100. In addition to securely storing communications in an encrypted form, all transmission of communications, metadata, and permissions between network service providers or between network service providers and use devices, are preferably encrypted before sending. Alternatively, a portion of the communication, metadata, and permissions are encrypted, while other portions are not encrypted.

Users who wish to access the distributed secure repository system undergo an authentication process before being permitted to access the system. In a preferred embodiment, the authentication process is implemented using single-sign-on technology, such as that offered using SAML or Kerberos. In a preferred embodiment, a recipient who is successfully authenticated by a sender service provider 105 advantageously undergoes an additional authentication validation before being allowed access to a desired communication or to otherwise interact with the system.

Security controls are preferably enforced using a combination of authentication and encryption strategies and protocols comprising the use of at least a portion of the set including: symmetric and asymmetric key technologies, cryptographic hashing algorithms, hardware and software-enabled random number generators, passwords or passphrases, biometric technologies, token-based security schemes, authentication challenges, as well as secure socket layer protected messaging.

FIG. 1 depicts one embodiment of the distributed secure repository system, including various data structures, software modules, communications links, and other structural components. It will be appreciated that functions carried out by the distributed secure repository may also be implemented by other configurations of the data structures, software modules, communications links, and other structural without departing from the spirit of the distributed secure repository system described herein. For example, in some embodiments, both sender metadata 125 and recipient metadata 130 are stored in a single repository by the users' service providers 105.

FIG. 2 depicts a simplified version of one embodiment of a user interface for an outgoing communication manager 200 that allows a user to view information about communications that the user has created and made available to other users. The outgoing communication manager 200 preferably works in conjunction with the communication editor 135 described with reference to FIG. 1 to allow a user to create communications, to define a recipient list and permissions associated with the communication, and to keep a record of information about the communication. As depicted in FIG. 2, the outgoing communication manager 200 includes a summary list 210 of outgoing communications. The summary list 210 preferably lists previously created communications by identification number. The summary list 210 also preferably provides information about when the communication was created and to whom the communication was made available. It will be appreciated by persons of ordinary skill in the art that other sets of information about previously created communications may advantageously be displayed to the sender by the outgoing communication manager 200. For example, some embodiments may include a date on which the communication was most recently modified.

A detail portion 220 of the outgoing communication manager 200 preferably provides additional information about a communication selected from the summary list 210. The embodiment of the detail portion 220 depicted in FIG. 2 advantageously allows the sender to take one or more modifying actions with respect to the communication, its recipient list, and associated permissions. The sender is provided with options to edit or to delete the communication, as implemented in the embodiment shown by the presentation to the sender of selector buttons 221-225. Selecting the Edit Communication button 221 allows the sender to view and, if desired, to modify the communication.

Two buttons 224, 225 depicted in FIG. 2 allow the sender to modify permissions that limit actions that a recipient may take with respect to the communication. A first Edit Permissions button 224 allows the sender to edit permissions that apply on a global basis to all recipients of the communication. A second Edit Permissions button 225 allows the sender to edit permissions as they apply to individual recipients of the communication. As depicted in the simplified version of the outgoing communication manager user interface 200 depicted in FIG. 2, the sender sets permissions limitations on the recipients' ability to save, print, or forward the communication. In a preferred embodiment, the sender is provided an option to specify whether the communication may be viewed only on devices within a secure location. For example, some user devices 100 may be known to reside within a secure location of a business premises, such as a high-security area where cameras and recording devices of all types are not permitted. When enforcement of this Secure Location Only policy is specified by the sender, the communication will be viewable only on secure viewers 145 of user machines that have been previously identified as meeting these criteria. It is also possible for a device to be designated as secure by a sender's organization. For example, in one embodiment, corporate issued laptops are deemed secure by a company's information technology (IT) staff and are allowed to receive communications of certain levels. Furthermore, in some embodiments, the sender is provided with options to set time-related permissions and instructions with respect to the communication. One such option allows a sender to specify a limited time frame during which the recipient may view the communication, or may specify that the communication be deleted once it is read. Another such option allows the recipient a limited time for editing or annotating a communication, after which time limit, the recipient is no longer permitted to modify the communication, although other permissions, such as a permission to view the communication, may remain available to the recipient. Furthermore, in other embodiments, other conditions, such as a limited number of copies printed or a limited list of acceptable recipients of a forwarded communication are set using the outgoing communication manager 200.

By selecting the Edit Recipient List button 223, the user effectively denies further access to the communication by recipients whose names are thus deleted. Although a newly deleted recipient may have previously viewed the communication, if the permissions associated with the communication prohibited viewers from storing the communication, then any former recipient who is no longer on the recipient list will no longer be provided access to the communication. If the user selects the Delete Communication button 222, access to the communication for any recipients who were not originally permitted to copy or store the communication is terminated. The ability for a sender to delete recipients from a recipient list associated with a communication and the ability for the sender to delete the sender's stored copy of the communication itself both exemplify methods in which the sender maintains control of a communication even after the sender sends the communication.

FIG. 3A depicts one embodiment of a repository of sender metadata 125, storing information about communications that a sender has sent. As depicted in FIG. 3A, the sender metadata 125 comprises an identifier for the sent communications. When a single server provider 105 serves a plurality of system users, embodiments of the sender metadata repository 125 on the service provider 105, such as the sender metadata repository 125 on User D's and User E's service provider 105, advantageously include an owner identifier for identifying the sender associated with a communication. Information about a storage location in the encrypted communications repository 115 in which the communication is stored advantageously allows for access of the communication by the sender or by authorized recipients requesting access to the communication from the sender's service provider 105. Content and keyword information, if it is provided by the sender of a communication, advantageously facilitates searching, sorting, and/or categorizing of the communications. Other information, including, for example, information about permissions and security controls associated with the communication, information about updates made to the communication, and information about recipients of the communication, are advantageously stored in the sender metadata 125 to allow support a range of searching, storing, retrieving, versioning, and tracking functions carried out on behalf of users of the system.

FIG. 3B depicts one embodiment of a repository of recipient metadata 130 that a recipient's service provider 105 receives from senders' service providers 105 about communications for the recipient. As depicted in FIG. 3B, the recipient metadata 130 for a communication comprises an identifier for the recipient, an identifier for the communication, and an identifier for the sender of the communication. The recipient metadata 130 for the communication preferably also comprises information that allows the recipient to contact the sender's service provider 105 in order to request the communication. Thus, in the embodiment shown in FIG. 3B, the recipient metadata 130 comprises a network access address for the sender's service provider 105 and a storage address within the encrypted communications repository 115 of the sender's service provider 105 where the communication is stored. Furthermore, when a sender revokes or otherwise modifies the recipient's permission to access a communication, network access and storage address information for the communication is preferably left as null values, if appropriate, and, advantageously, information, about the modification may be stored in the recipient metadata 130 repository and may invoke a pop-up or other notification on the user machine.

In some embodiments, the recipient metadata 130 advantageously includes other information, such as information about a type or category of the communication. Such category information, in some embodiments, indicates if the communication is new or is an update of a previously received communication. Category information, in some embodiments, indicates an importance level that the sender attaches to the communication and wishes for the recipient to know. Category information, in some embodiments, indicates whether the communication is a secure personal message, a document for shared authorship, other type of text document, graphics document, multimedia document, or the like. Other information, such as version information, for embodiments that allow tracking of versions, is preferably included in the repository of recipient metadata 130. A skilled artisan will appreciate, in light of this disclosure, that other information can be stored in the recipient metadata 130 without departing from the scope of the invention.

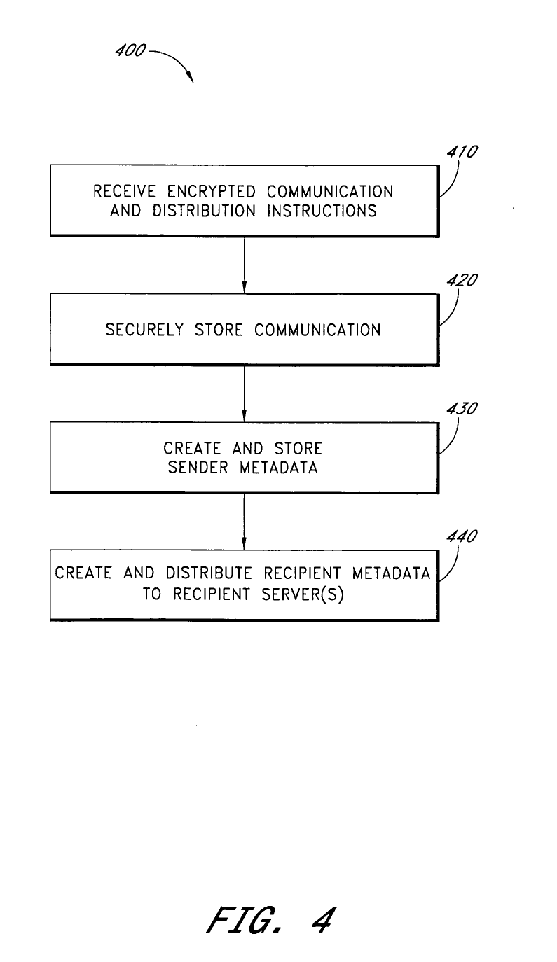

FIG. 4 is a flowchart of one embodiment of a process 400 for notifying a recipient about a communication. In Block 410, an encrypted communication is received, together with associated distribution instructions that preferably include a recipient list and a set of permissions specifying activities that recipients may take with regard to the communication. In one embodiment, the sender's service provider 105 receives the encrypted communication and the associated distribution instructions.

In Block 420, the encrypted communication is securely stored. In one embodiment, the sender's service provider 105 securely stores the encrypted communication in the encrypted communications repository 115.

In Block 430, sender metadata 125 associated with the communication is created and stored. In one embodiment, the sender's service provider 105 uses information obtained from the sender together with information obtained from other sources to create sender metadata for an outgoing communication and to store the sender metadata in the sender metadata repository 125. Examples of information obtained from the sender preferably include the recipient list and permissions associated with the communication. In some embodiments, information obtained from the sender further includes keywords and categorizing information provided by the user.

In Block 440, recipient metadata is created and distributed to service providers 105 associated with users on the recipient list of the communication. In one embodiment, the sender's service provider 105 creates the recipient metadata. The recipient metadata preferably includes data about the communication that identifies the communication and the sender of the communication for the recipient(s) of the communication and that provides access information that allows the recipient(s) of the communication to locate the encrypted stored communication. For example, in a preferred embodiment, the recipient metadata includes information that specifies a machine identifier that identifies an address for the sender's service provider 105 and a sub-location that identifies an address in the service provider's repository of encrypted communications 115 where the communication is stored. In some embodiments, information about a communications/security protocol to use for communicating with the sender's service provider 105 is also included in the recipient metadata sent to the recipient's service provider 105. In one embodiment, the remote access manager 120 and security module 110 encrypt the recipient metadata for secure transmission to service providers 105 associated with users on the recipient list of the communication. As described with reference to FIG. 1, the remote access manager 120 accesses address information for the recipient in the central directory 150 if the access information is not locally available.

FIG. 5 is a flowchart of one embodiment of a process 500 for allowing a permitted access to a communication by a recipient who requests the access. In Block 510, a login with authentication from a recipient of the communication is received. In a preferred embodiment, the sender's service provider 105 accepts a request from the recipient to initiate a secure communications session with the service provider 105. The recipient offers a form of authentication proof to verify the recipient's identity. In various embodiments, the authentication proof may be implemented using biometric information, a token, such as a smart card or dongle, a password, an extensible mark-up language (XML) token, or a combination of at least a portion of the foregoing. In a preferred embodiment, the recipient receives the authentication proof from the recipient's service provider 105 as part of a single-sign-on protocol, such as may be implemented using Kerberos, a network authentication protocol developed at Massachusetts Institute of Technology, or a Security Assertions Markup Language (SAML) security assertion.

To provide additional verification of the recipient's authentication, in one preferred embodiment, the sender's service provider communicates with the recipient's service provider to validate the recipient's authentication. In another preferred embodiment, the sender's service provider 105 requests additional authentication on a first interaction between a recipient 100 and the sender's server. For example, the sender service provider 105 requests at least one of: a cryptographic token or protocol, or a simple entry of a pre-agreed piece of data, such as a password or passphrase, an access number, or other data communicated offline or “out-of-band” to the recipient. Thus, a company wishing to use the distributed secure repository system with users who are their customers may communicate an access code to customers via a letter, to further ensure correct identification of the recipient.

In Block 520, once the recipient's authentication is accepted, a session with the recipient is initiated and a request from the recipient to access the communication is received. In one embodiment, the sender's service provider initiates the session with the recipient and receives a request for access to the communication that is based on the recipient metadata for the communication. Thus, the recipient request includes information about the storage location of the encrypted communication. In other embodiments, the sender's service provider 105 performs a look-up operation, such as a look-up on the sender metadata 125, to determine the communication's location.

In Block 530, an encrypted copy of the requested communication is sent to the recipient. In one embodiment, the sender's service provider sends the encrypted copy of the requested communication to the recipient. In a preferred embodiment, the sender's service provider additionally sends encrypted information indicative of permissions and other access instructions associated with the communication to the recipient, and the recipient views or otherwise accesses the communication using the recipient's secure viewer 145 and in accordance with the permissions received from the sender's service provider.

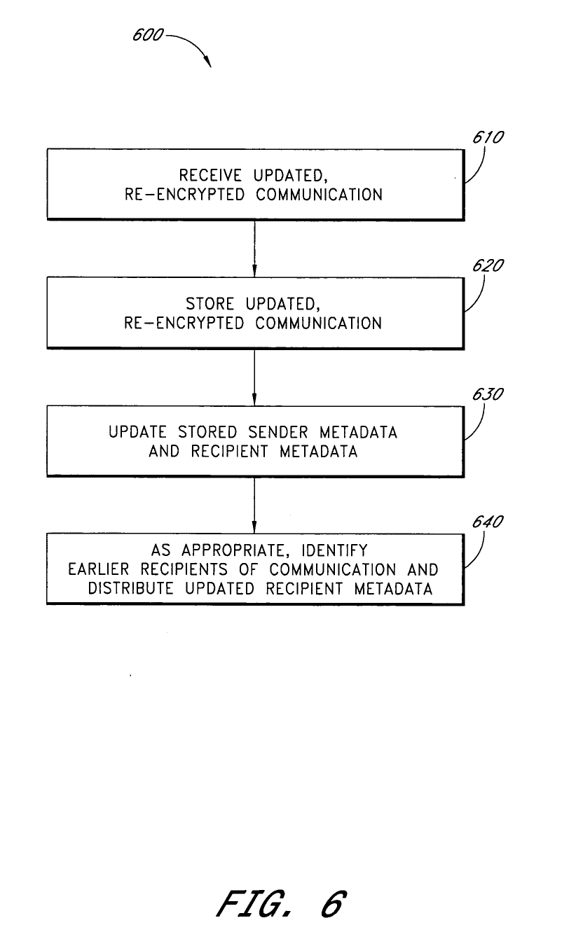

FIG. 6 is a flowchart of one embodiment of a process 600 for allowing a sender to update a communication. In Block 610, an updated, re-encrypted communication is received. In one embodiment, the sender's service provider receives an updated version of a previously created communication. The sender re-encrypts the communication after updating it and before transmitting it to the sender's service provider 105.

In Block 620, the updated communication is stored. In one embodiment, the sender's service provider stores the updated communication in the repository of encrypted communications 115. In one embodiment where versions of communications are not archived, the sender's service provider replaces the stored copy of the original communication in the repository of encrypted communications 115 with the updated and re-encrypted version of the communication. In one embodiment where versions of communications are archived, the sender's service provider stores the updated and re-encrypted version of the communication in the repository of encrypted communications 115 without replacing the stored copy of the original communication.

In Block 630, the sender metadata 125 and recipient metadata associated with the communication are updated to include new information associated with the updated communication. In one embodiment, the sender's service provider updates the sender data 125 and recipient metadata associated with the updated communication. For example, if the updated communication is stored in a new location within the encrypted communications repository 115, the updated sender metadata 125 includes the new storage location. If permissions or the recipient list associated with the communication have been updated, the updated sender metadata 125 includes the new information.

In one embodiment where versions of communications are not archived, the sender's service provider preferably replaces the sender metadata 125 of the original communication with the updated version of the sender metadata 125. In one embodiment where versions of communications are archived, the sender's service provider preferably stores the updated sender metadata 125, including an indication identifying the version of the updated communication, without replacing the stored sender metadata 125 associated with the original communication.

Similarly, recipient metadata associated with the communication is updated to reflect the current storage location, permissions, and, if relevant, the version identifier for the updated communication. In a preferred embodiment, the recipient metadata for an updated communication includes an indication that the communication has been updated.

In Block 640, if desired by the sender, earlier recipients of the communication are identified and the updated recipient metadata is distributed to the earlier recipients, notifying them of the update. In one embodiment, the sender's service provider, if instructed to do so by the sender, identifies earlier recipients of the communication and distributes the updated recipient metadata to the service providers of the earlier recipients. If the sender has updated the recipient list for the communication, the sender's service provider preferably distributes the updated recipient metadata to the service providers of the recipients on the updated recipient list. In a preferred embodiment, network service providers 105 of recipients whose permissions have been modified are notified of the change.

FIG. 7 is a flowchart of one embodiment of a process 700 for receiving a communication.

In Block 710, recipient metadata about new and updated communications is received. In one embodiment, the recipient's service provider 105 receives and stores recipient metadata 130 from senders who have created or updated communications for access by the recipient.

In Block 720, the recipient is authenticated. In one embodiment, the recipient's service provider 105 authenticates the recipient. In a preferred embodiment, the recipient logs in to the recipient's service provider and enters into a password dialog with the service provider that invokes a cryptographic challenge-response, which if successful, results in the recipient's service provider issuing the recipient an XML token embedded within a SAML communication. Alternatively, the recipient's service provider 105 uses another single sign-on protocol, such as the Kerberos protocol, to authenticate the recipient and to provide the recipient, if authenticated, with access to the distributed secure repository system.

In Block 730, the newly received metadata is synchronized with the recipient's communication list 140. In one embodiment, the recipient's network service provider 105 transmits information about additions and updates in the recipient metadata 130 to the communication list 140 on the recipient's user device.

In Block 740, a selection is made from the communication list 140 that initiates a request from the sender's network service provider 105 to permit access to the selected communication. In a preferred embodiment, the recipient makes the selection and initiates the request. In another embodiment, the recipient's network service provider 105 makes the request on behalf of the recipient.

The systems and methods described herein have been described with reference to various preferred and exemplary embodiments. While the foregoing preferred embodiments are seen to provide certain advantages, many other embodiments are encompassed by the invention. In general, the features described herein with regard to certain embodiments are not required features of the invention. As such, the embodiments described herein are offered for the purpose of providing useful examples of how to practice the invention, not as limitations on the invention. In many cases, features that are part of certain embodiments can be omitted from other embodiments without departing from the scope of the invention. Additionally, a skilled artisan will appreciate, from this disclosure, how to implement variations of the invention that are not explicitly stated herein but which are apparent from the disclosure and the principles described herein. Such variations, in addition to those explicitly described, are encompassed within the scope of the invention.

Claims have been provided herein to define the invention. Each claim provides a full definition of the invention without the importation of additional limitations from this written description. It is anticipated that amended claims may be presented in the future and that such amended claims will also provide a full definition of the invention without the importation of additional limitations from the written description. With that in mind, the claims follow.

What is claimed is:

1. A system for securely managing communications between a sender of a communication and a recipient of the communication across a computer network such that the sender sets permissions associated with the communication which limit actions that the recipient is permitted to take with respect to the communication and such that the sender retains control of the communication, even after the communication is accessed by the recipient, the system comprising:
a sender computer device with a communication manager that allows the sender to: identify a communication that the sender wishes to make available to the recipient, set permissions limiting the activities which the recipient is permitted to carry out with respect to the communication, and create a recipient list for the communication that includes the recipient;
a sender network service provider in communication with the sender computer device configured to receive an encrypted copy of the communication as well as the permissions and recipient list associated with the communication, the sender network service provider further configured to generate recipient metadata about the communication, wherein the recipient metadata about the communication comprises information that allows the recipient to contact the sender network service provider with a request for the communication, the sender network service provider comprising:
a secure communications repository for storing the encrypted copy of the communication; and
a security module which, in conjunction with a remote access manager module, is configured to oversee secure storage and network transmission of communications, recipient metadata, permissions, and recipient lists, and to authenticate the identity of any entity that contacts the sender network service provider, claiming to be the recipient and requesting access to the communication;
a recipient network service provider, capable of receiving transmissions from the sender network service provider, the recipient network service provider comprising:
a repository of recipient metadata for storing recipient metadata about the communication received from the sender network service provider; and
a security module which oversees the secure storage of the recipient metadata and which provides single sign-on authentication for the recipient that allows the recipient access to the system; and
a recipient computer device, in communication with the recipient network service provider, comprising:
a communications list that displays for the recipient a listing, which is based at least in part on the recipient metadata received from the recipient network service provider, of communications that users of the system wish to make available to the recipient, including the communication from the sender, and that receives instructions from the recipient to use the recipient metadata and the single sign-on authentication to contact the sender network service provider with a request for a secure copy of the encrypted communication and the permissions; and
a secure viewer for displaying to the recipient a decrypted version of the communication, if permitted by the permissions, and for enforcing the permissions, which limit the recipient's ability to carry out activities with respect to the communication, such as viewing, storing, modifying, creating a screen shot, or forwarding the communication.

2. A method for managing communications that are transmitted over a computer network between a sender and a recipient, wherein the sender retains control over the communication, even after transmission to the recipient, and wherein the sender is provided with mechanisms for setting permissions that limit activities, such as viewing, copying, modifying, storing, forwarding, and printing, that the recipient is permitted to carry out with respect to the communication, the method comprising:
receiving from a sender a communication that the sender wishes to share with a recipient;
receiving from the sender a recipient list and a set of permissions in association with the communication;
securely storing the communication;
generating metadata associated with the communication and transmitting the metadata to the recipient, wherein the metadata comprises information that identifies the sender, the communication, a network address and other locating information for the securely stored communication and that allows the recipient to transmit a request for the communication;
receiving a request for the communication from an entity claiming to be the recipient;
validating the entity's identity as the recipient; and
securely sending an encrypted version of the communication to the recipient along with the permissions, wherein the communication is viewable only on a secure viewer that is configured to enforce the permissions set received from the sender.

3. A system for securely managing communications between a sender of a communication and a recipient of the communication across a computer network such that the sender sets permissions associated with the communication which limit actions that the recipient is permitted to take with respect to the communication and such that the sender retains control of the communication, even after the communication is accessed by the recipient, the system comprising:
a communication manager on a sender computer device that allows the sender to set permissions with respect to a communication that the sender wishes to share with a recipient, wherein the permissions place limitations on activities that the recipient is permitted to carry out with respect to the communication, such as limiting the recipient's ability to view the communication, print the communication, store the communication, modify the communication, copy the communication, forward the communication, and such as limiting time periods during which the recipient may carry out an activity with respect to the communication, and such as limiting a number of times that the recipient may carry out an activity with respect to the communication;
a sender network service provider in communication with the communication manager on the sender computer device, wherein the sender service provider is configured to:
accept from the communication manager an encrypted copy of the communication, the permissions associated with the communication, and a recipient list associated with the communication that lists the recipient;
securely store the encrypted communication in a repository of encrypted communications;
create and store recipient metadata about the communication that is based at least in part on the recipient list, the encrypted communication, and the permissions received from the communication manager, and that further comprises information which allows the recipient to contact the sender network service provider with a request for the communication;
send the recipient metadata;
receive on behalf of the recipient a request for the communication; and
if permitted by the permissions associated with the communication, send an encrypted copy of the communication and the permissions for the recipient;
a recipient network service provider configured to receive and store the recipient metadata from the sender network service provider; and
a recipient computer device in communication with the recipient network provider configured to:
receive the recipient metadata from the recipient service provider;
use information in the recipient metadata to establish a connection with the sender service provider;
send a request for the communication to the sender service provider;
if permitted by the permissions, receive an encrypted copy of the communication and the associated permissions;
if permitted by the permissions, display to the recipient a decrypted version of the communication on a secure viewer that is configured to enforce the permissions; and
if permitted by the permissions, carry out another activity with respect to the communication.

4. A computer-based method for securely managing a communication between a sender and a recipient, the method comprising the acts of:
receiving an encrypted communication that a sender wants to make accessible to a recipient;
securely storing the encrypted communication;
storing sender metadata associated with the communication, wherein the sender metadata comprises information about a set of actions that the sender allows the recipient to take with regard to the communication;
sending recipient metadata to a computer server associated with the recipient to notify the recipient about the communication;
accepting an authenticated login from the recipient;
receiving a request from the recipient to take an action with regard to the communication; and
permitting the recipient to take the action if the sender metadata indicates that the sender allows the recipient to take the action.

5. The computer-based method of claim 4, wherein permitting the recipient to take the action includes permitting the recipient to perform at least one of the acts of: receiving an encrypted copy of the encrypted communication, storing an encrypted copy of the communication, reading the communication, listening to the communication, forwarding the communication, copying the communication, editing the communication, printing the communication, and replying to the communication.

6. The computer-based method of claim 4, further comprising:
updating the sender metadata associated with the communication;
storing the updated sender metadata; and
notifying the recipient's server about the updated sender metadata.

7. The computer-based method of claim 6, further comprising:
receiving an updated and encrypted version of the communication; and
securely storing the encrypted updated, encrypted communication.

8. The computer-based method of claim 6, wherein updating the sender metadata comprises changing the set of actions that the sender allows the recipient to take with regard to the communication.

9. A computer-based system for managing a communication between a sender and a recipient, the system comprising:
a first repository maintained by a sender for securely storing an encrypted version of a communication;
a second repository maintained by the sender for storing sender metadata associated with the communication;
a communications system accessible to the sender for sending recipient metadata associated with the communication to a computer server associated with the recipient, wherein the recipient metadata provides an indication to the recipient server of how to access the communication.

10. The computer-based system of claim 9, wherein:
the communications system is further configured to receive a request from the recipient to receive a copy of the communication, and, upon authenticating the recipient, to transmit a copy of the communication to the recipient.

11. A computer-based method for managing communication notifications received by a recipient, the method comprising:
maintaining a repository of listings that comprise information about communications that one or more senders are securely storing and are providing permission to access; and
using at least a portion of one listing associated with one accessible communication to communicate with a computer server associated with the sender of the communication, requesting to perform a permitted action with regard to the communication, wherein the sender determines if the action is permitted to the recipient.

12. The computer-based method of claim 11, further comprising gaining authenticated access to computer servers associated with the listings in the repository using a single-sign-on mechanism.

13. The computer-based method of claim 11, wherein requesting to perform a permitted action comprises requesting to view a copy of the communication on a secure viewer.

14. The computer-based method of claim 11, wherein requesting to perform a permitted action comprises requesting to perform at least one action including: storing an encrypted copy of the communication, listening to the communication, forwarding the communication, copying the communication, editing the communication, printing the communication, and replying to the communication.

15. A computer-based communications system, the system comprising:
a first network service provider that manages data communications for a first user;
a central directory, accessible to the first network service provider, the central directory comprising information for accessing a second network service provider;
a database comprising at least one encrypted file stored by the first network service provider on behalf of the first user;
metadata about the encrypted file stored by the first network service provider, wherein the metadata comprises permissions that limit the second user's ability to perform actions with respect to the file; and
secure repository server software stored by the first network service provider, wherein the secure repository server software is configured to receive the information for accessing the second network service provider, to open a communication channel with the second network service provider; and to transmit at least a portion of the metadata to the second network service provider for passing to the second user.

16. The computer-based communications system of claim 15, further comprising:
secure repository end user software accessible to the second user; and
a secure viewer controlled by the secure repository end user software for allowing the second user to view the view a decrypted version of the encrypted file.

17. The computer-based communications system of claim 15, wherein a single network service provider provides the first network service provider and the second network service provider.

18. The computer-based communications system of claim 15, wherein the first network service provider and the second network service provider are two different network service providers.

19. A computer-based communications system, the system comprising:
a first network service provider that manages data communications for a first user and that is configured to access information for accessing a second network service provider;
a database comprising at least one encrypted file stored by the first network service provider on behalf of the first user;
metadata about the encrypted file stored by the first network service provider, wherein the metadata comprises permissions that limit the second user's ability to perform actions with respect to the file; and
distributed secure repository server software stored by the first network service provider, wherein the secure repository server software is configured to receive the information for accessing the second network service provider, to open a communication channel with the second network service provider; and to transmit at least a portion of the metadata to the second network service provider for passing to the second user.

20. A computer-based communications system, the system comprising:
a first network service provider that manages data communications for a first user and that is configured to access information for accessing a second network service provider using at least one relationship-managed communications channel;
a database comprising at least one encrypted file stored by the first network service provider on behalf of the first user;
metadata about the encrypted file stored by the first network service provider, wherein the metadata comprises permissions that limit the second user's ability to perform actions with respect to the file; and
distributed secure repository server software stored by the first network service provider, wherein the secure repository server software is configured to receive the information for accessing the second network service provider, to open a relationship-managed communication channel with the second network service provider; and to transmit at least a portion of the metadata to the second network service provider for passing to the second user.

21. A computer-based communications system, the system comprising:
means for receiving an encrypted communication that a sender wants to make accessible to a recipient;
means for securely storing the encrypted communication;
means for storing sender metadata associated with the communication, wherein the sender metadata comprises information about a set of actions that the sender allows the recipient to take with regard to the communication;
means for sending recipient metadata to a computer server associated with the recipient to notify the recipient about the communication;
means for accepting an authenticated login from the recipient;
means for receiving a request from the recipient to take an action with regard to the communication; and
means for permitting the recipient to take the action if the sender metadata indicates that the sender allows the recipient to take the action.
